(19) United States
(12) Patent Application Publication
(10) Pub. No.: US 2026/0287775 A1
(43) Pub. Date: Sep. 24, 2026

(54) SYSTEMS AND METHODS FOR OPTIMIZING SEISMIC SURVEYS TO ENHANCE FULL WAVEFORM INVERSION FOR MODELING SUBSURFACE REGIONS

(71) Applicant: BP Corporation North America Inc., Houston, TX (US)

(72) Inventor: Imtiaz Ahmed, Katy, TX (US)

(73) Assignee: BP Corporation North America Inc., Houston, TX (US)

(21) Appl. No.: 19/559,336

(22) Filed: Mar. 6, 2026

Related U.S. Application Data
(60) Provisional application No. 63/775,695, filed on Mar. 21, 2025.

(51) Int. Cl. G01V 1/30; G01V 1/28

(52) U.S. Cl. CPC G01V 1/307; G01V 1/282; G01V 2210/63

(57) ABSTRACT

A method for optimizing a seismic survey to enhance FWI for modeling a subsurface region including receiving a subsurface model of the subsurface region, generating synthetic seismic data using the subsurface model, generating a plurality of RTM gathers from the synthetic seismic data, stacking the plurality of RTM gathers to estimate one or more subsurface kernels of the subsurface region, selecting one or more AOIs of the subsurface region, and performing a seismic energy contribution analysis using the RTM gathers to identify optimized locations of at least one of one or more seismic sources along a source surface and one or more seismic receivers along a recording surface that contributes a maximal amount of seismic energy to the one or more selected AOIs and corresponding to the at least one of the one or more subsurface kernels.

### CROSS-REFERENCE TO RELATED APPLICATIONS

This application claims benefit of U.S. provisional patent application Ser. No. 63/775,695 filed Mar. 21, 2025, and entitled “Systems and Methods for Optimizing Seismic Surveys to Enhance Full Waveform Inversion for Modeling Subsurface Regions,” which is hereby incorporated herein by reference in its entirety for all purposes.

### BACKGROUND

Seismic surveying is a method of exploration geophysics in which seismology is used to estimate properties of earthen subsurface regions from seismic reflection waves. Seismic surveying generally includes imparting acoustic or sound waves into a natural environment so that the waves enter the Earth and travel through a subsurface region of interest. As the seismic waves encounter an interface between two materials of the subsurface region, some of the wave energy is reflected off the interface where the seismic reflection wave energy may be observed or collected at the surface as seismic data associated with the subsurface region, while some of the wave energy refracts through the interface and penetrates deeper into the subsurface region. The seismic reflection wave energy observed at the surface as seismic data may be studied to ascertain information about the subsurface region. For example, the observed seismic data may be used to construct a velocity model of the subsurface region which models the velocity of the seismic waves passing through the subsurface region so as to translate subsurface reflection points of the seismic waves to their true depth within the formation. The seismic data observed by the receivers may also be used to create an image or profile of the corresponding subsurface region. Interpretation of these seismic images may provide a description of the geological features of the subsurface, such as faults, salts domes, anticlines, or other features indicative of the location and/or change in hydrocarbon deposits.

### SUMMARY

An embodiment of a method for optimizing a seismic survey to enhance full-waveform inversion (FWI) for modeling a subsurface region comprises (a) receiving a subsurface model of the subsurface region, (b) generating synthetic seismic data using the subsurface model, (c) generating a plurality of reverse time migration (RTM) gathers from the synthetic seismic data, (d) stacking the plurality of RTM gathers to estimate one or more subsurface kernels of the subsurface region, (e) selecting one or more areas of interest (AOIs) of the subsurface region, and (f) performing a seismic energy contribution analysis using the RTM gathers to identify optimized locations of at least one of one or more seismic sources along a source surface and one or more seismic receivers along a recording surface that contributes a maximal amount of seismic energy to the one or more selected AOIs and corresponding to the at least one of the one or more subsurface kernels. In some embodiments, (g) performing a seismic survey of the subsurface region with at least one of the one or more seismic sources positioned along the source surface and the one or more seismic receivers positioned along the recording surface located at the identified optimized location to obtain observed seismic data. In some embodiments, (g) comprises dividing the one or more seismic sources into a plurality of separate seismic source classes based on the seismic energy contribution analysis, wherein each of the plurality of separate seismic source classes has a unique maximum crossline offset. In certain embodiments, (g) comprises dividing the one or more seismic sources into one or more static seismic receivers and one or more rolling seismic receivers. In certain embodiments, the method comprises (h) tuning the subsurface model of the subsurface region using the observed seismic data. In some embodiments, the method comprises (i) generating one or more seismic images of the subsurface region using the preconditioned and reverse propagated observed seismic data. In some embodiments, the optimized locations contribute the maximal amount of seismic energy to the one or more selected AOIs and at least one subsurface kernel of the one or more subsurface kernels other than a reflection subsurface kernel that intercepts the one or more selected AOIs. In certain embodiments, the one or more selected AOIs are intercepted by the at least one subsurface kernel. In certain embodiments, the one or more selected AOIs are not intercepted by the at least one subsurface kernel.

An embodiment of a method for optimizing a seismic survey to enhance full-waveform inversion (FWI) for modeling a subsurface region comprises (a) receiving a subsurface model of the subsurface region, (b) selecting one or more areas of interest (AOIs) of the subsurface region, and (c) performing a seismic survey of the subsurface region with one or more seismic sources positioned along a source surface and a plurality of seismic receivers positioned along a recording surface, the plurality of seismic receivers divided into a plurality of separate receiver classifications each having a unique maximum crossline offset to obtain observed seismic data from the plurality of seismic receivers, and (d) generating one or more seismic images of the one or more selected AOIs using the observed seismic data and the subsurface model. In some embodiments, (c) comprises (c1) transporting the one or more seismic sources across a survey area of the seismic survey in a crossline direction, (c2) transporting a first class of seismic receivers of the plurality of seismic receivers across the recording surface in response to the one or more seismic receivers reaching a first maximum crossline offset of the first class of seismic receivers relative to the one or more seismic sources as the one or more seismic sources travel in the crossline direction, and (c3) transporting a second class of seismic receivers of the plurality of seismic receivers across the recording surface in response to the one or more seismic receivers reaching a second maximum crossline offset of the second class of seismic receivers relative to the one or more seismic sources as the one or more seismic sources travel in the crossline direction, wherein the second maximum crossline offset is greater than the first maximum crossline offset. In some embodiments, (c2) comprises transporting the first class of seismic receivers in the crossline direction across the recording surface. In certain embodiments, (c) comprises (c1) transporting the one or more seismic sources across a survey area of the seismic survey in a crossline direction, (c2) maintaining a first class of seismic receivers of the plurality of seismic receivers in a static location along the recording surface until the completion of the seismic survey, and (c3) transporting a second class of seismic receivers of the plurality of seismic receivers across the recording surface in response to the one or more seismic receivers reaching a maximum crossline offset of the second class of seismic receivers relative to the one or more seismic sources as the one or more seismic sources travel in the crossline direction. In certain embodiments, the method comprises (e) performing a seismic energy contribution analysis to identify optimized locations of the plurality of seismic receivers along the recording surface that contributes a maximal amount of diving wave energy to the one or more selected AOIs. In some embodiments, seismic receivers of the plurality of seismic receivers located at the optimized locations along the recording surface have a maximum crossline offset that is greater than a maximum crossline offset of other seismic receivers of the plurality of seismic receivers that are not located at the optimized locations.

An embodiment of a system comprises a one or more processors, and a storage device coupled to the one or more processors, the storage device configured to store instructions that, when executed by the one or more processors, configure the one or more processors to (a) receive a subsurface model of the subsurface region, (b) generate synthetic seismic data using the subsurface model, (c) generating a plurality of reverse time migration (RTM) gathers from the synthetic seismic data, (d) stack the plurality of RTM gathers to estimate one or more subsurface kernels of the subsurface region, and (e) perform a seismic energy contribution analysis using the RTM gathers to identify optimized locations of at least one of one or more seismic sources along a source surface and one or more seismic receivers along a recording surface that contributes a maximal amount of seismic energy to one or more selected area of interest (AOIs) and corresponding to the at least one of the one or more subsurface kernels. In some embodiments, the instructions, when executed by the one or more processors, configure the one or more processors to (f) receive observed seismic data from the subsurface region, and (g) tune subsurface model of the subsurface region using the observed seismic data. In certain embodiments, the instructions, when executed by the one or more processors, configure the one or more processors to (h) generate one or more seismic images of the subsurface region using the preconditioned and reverse propagated observed seismic data. In certain embodiments, the optimized locations contribute the maximal amount of seismic energy to the one or more selected AOIs and at least one subsurface kernel of the one or more subsurface kernels other than a reflection subsurface kernel that intercepts the one or more selected AOIs. In some embodiments, the one or more selected AOIs are intercepted by the at least one subsurface kernel. In some embodiments, the one or more selected AOIs are not intercepted by the at least one subsurface kernel.

### BRIEF DESCRIPTION OF THE DRAWINGS

For a detailed description of various exemplary embodiments, reference will now be made to the accompanying drawings in which:

FIG. 1 is a flow chart of various processes that may be performed based on analysis of seismic data acquired via a seismic survey system in accordance with principles disclosed herein;

FIG. 2 is a schematic diagram of an embodiment of a system for performing a land-based seismic survey in accordance with principles disclosed herein;

FIG. 3 is a schematic diagram of an embodiment of a system for performing a marine seismic survey in accordance with principles disclosed herein;

FIGS. 4A-4C are schematic diagrams of another embodiment of a system for performing a marine seismic survey in accordance with principles disclosed herein;

FIG. 5 is a block diagram of an embodiment of a computer system that may perform operations described herein based on data acquired via a survey system in accordance with principles disclosed herein;

FIGS. 6 and 7 are schematic diagrams of additional embodiments of systems for performing a seismic survey in accordance with principles disclosed herein;

FIG. 8 is a flowchart illustrating an embodiment of a method for optimizing a seismic survey to enhance full-waveform inversion for modeling a subsurface region in accordance with principles disclosed herein;

FIG. 9 is a diagram illustrating an exemplary seismic energy contribution analysis in accordance with principles disclosed herein;

FIG. 10 is a diagram illustrating an exemplary distribution of seismic receivers of a seismic survey in accordance with principles disclosed herein; and

FIGS. 11 and 12 are flowcharts illustrating embodiments of methods for optimizing a seismic survey to enhance FWI for modeling a subsurface region in accordance with the principles disclosed herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

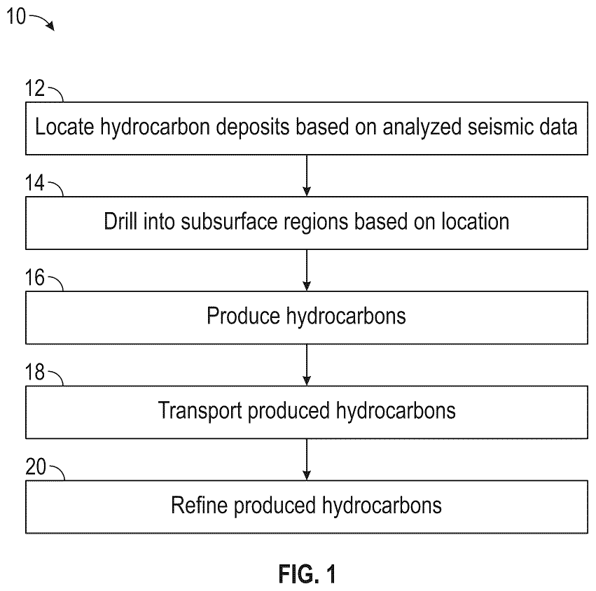

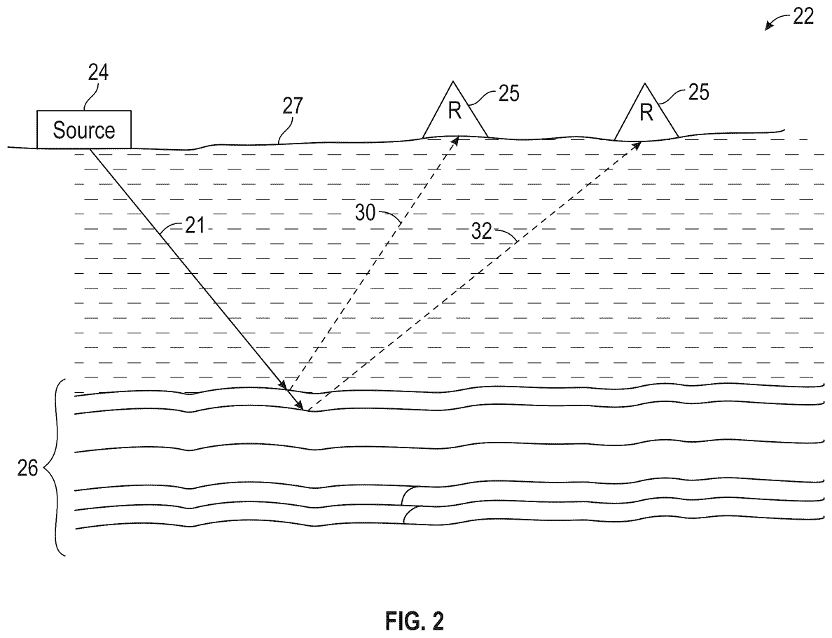

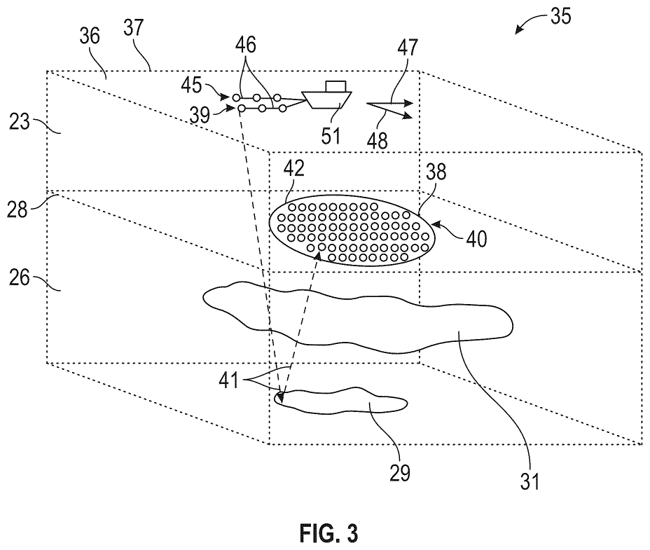

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computer system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to method 10 may include other suitable processes that may be based on the locations and properties of hydrocarbon deposits as indicated in the seismic data acquired via one or more seismic survey. As such, the processes described above are not intended to depict an exhaustive list of processes that may be performed after determining the locations and properties of hydrocarbon deposits within the subsurface region.

Referring to FIG. 2, an exemplary land survey system 22 (e.g., for use in conjunction with block 12 of FIG. 1) that may be employed to obtain information regarding a subsurface region 26 of the Earth in a non-marine environment is shown. The land survey system 22 may include a land-based seismic source 24 and land-based receiver 25. In some embodiments, the land survey system 22 may include multiple land-based seismic sources 24 and one or more land-based receivers 25. Indeed, for discussion purposes, the land survey system 22 includes a land-based seismic source 24 and two land-based receivers 25. The land-based seismic source 24 (e.g., seismic vibrator) that may be disposed on a surface 27 of the Earth above the subsurface region 26 of interest. The land-based seismic source 24 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 24 may be reflected off the geological formations and acquired or observed by one or more land-based receivers (e.g., 25 and 26).

In certain embodiments, the land-based receivers 25 may be dispersed across the surface 27 of the Earth to form a grid-like pattern. As such, each land-based receiver 25 or 26 may receive a reflected seismic waveform in response to energy being directed at the subsurface region 26 via seismic source 24. In some cases, one seismic waveform produced by the seismic source 24 may be reflected off of different geological formations and received by different receivers. For example, as shown in FIG. 2, the seismic source 24 may output energy that may be directed at the subsurface region 26 as seismic waveform 21. A first receiver 25 may receive the reflection of the seismic waveform 21 off one geological formation and a second receiver 25 may receive the reflection of the seismic waveform 21 off a different geological formation. As such, the first receiver 25 may receive a reflected seismic waveform 30 and the second receiver 25 may receive a reflected seismic waveform 32.

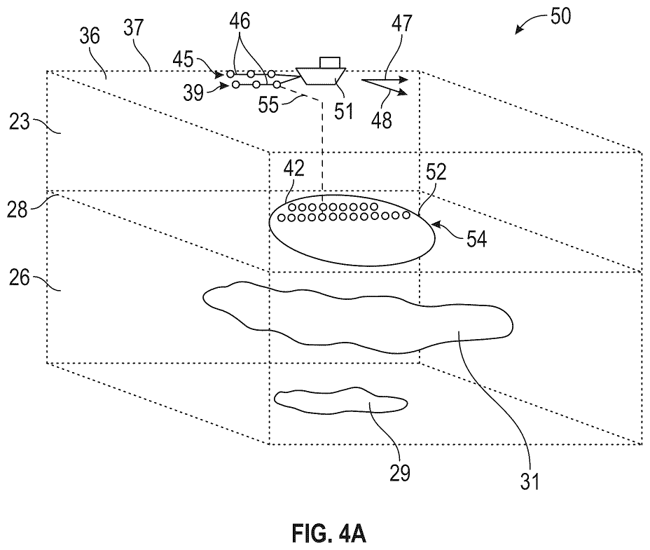

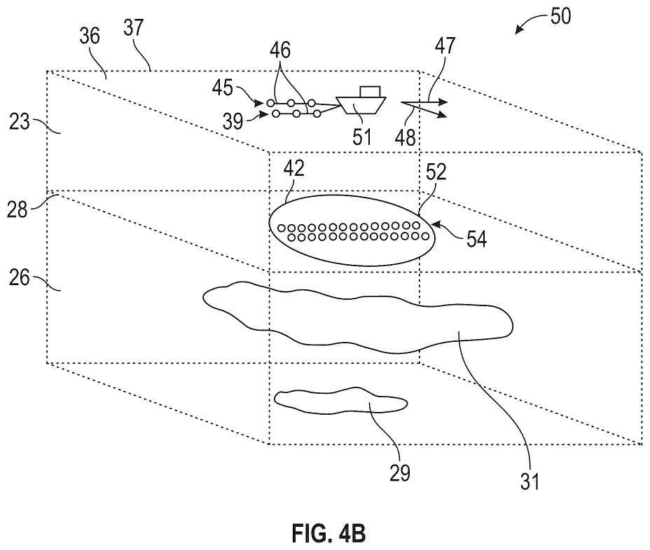

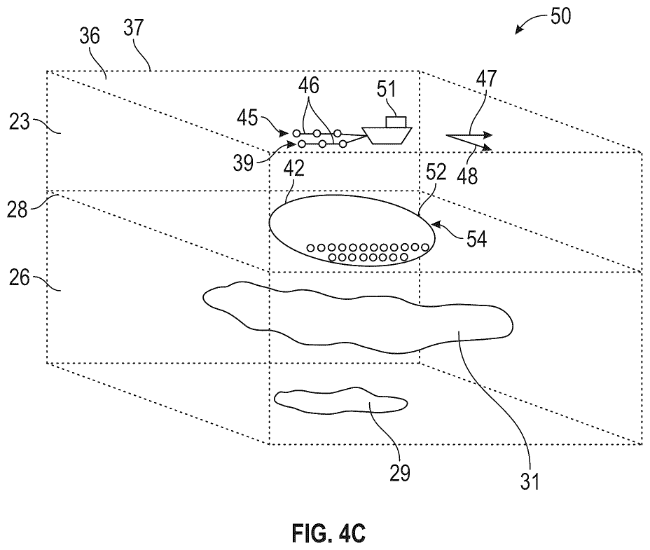

Regardless of how the seismic data is acquired, a computer system (e.g., for use in conjunction with block 12 of FIG. 1) may analyze the seismic waveforms acquired by the receivers 25 to determine seismic information regarding the geological structure, the location and property of hydrocarbon deposits, and the like within the subsurface region 26. FIG. 4 is a block diagram of an example of such a computer system 60 that may perform various data analysis operations to analyze the seismic data acquired by the receivers 25 to determine the structure and/or predict seismic properties of the geological formations within the subsurface region 26.

With the foregoing in mind, FIG. 3 is a schematic diagram of a marine survey system 35 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 35 may be conducted along a water column 23 or other body of water over the subsurface region 26 of the Earth that lies beneath a seabed 28.

In this exemplary embodiment, the seismic survey performed by survey system 35 may be conducted in a survey area 36 which includes the water column 23 extending from the sea bottom or seabed 28 to a water's surface or waterline 37. The survey area 36 additionally includes subsurface region 26 extending beneath the seabed 28 and which includes an AOI 29 positioned beneath the seabed 28. The AOI 29 may be an area or section of the subsurface region 26 which may include hydrocarbon deposits or other materials of interest. Additionally, in this exemplary embodiment, a subterranean intervening feature 31 is positioned between the AOI 29 and the seabed 28. The intervening feature 31 may comprise a variety of subterranean features such as, for example, allochthonous salt or other features which may distort a seismic image unless adequately accounted for in a velocity model. In some applications, a plurality of intervening features 31 may be positioned between the AOI 29 and the seabed 28.

In this exemplary embodiment, survey system 35 generally includes a node grid or patch 38 positioned at the seabed 28, an array 39 of seismic sources (indicated generally by arrow 45 in FIG. 3) transported by a surface vessel 51 located at the waterline 37. Node patch 38 comprises a plurality of seismic receivers or nodes (indicated generally by arrow 40 in FIG. 3) configured to receive seismic energy or waves (indicated by arrows 41 in FIG. 3) produced by the seismic sources 45 that have interacted with the subsurface region 26 and returned towards the surface, either by reflection, refraction, and/or by turning as diving waves. In some embodiments, seismic nodes 40 may be positioned at the seabed 28 by surface vessel 51 and/or another vessel of survey system 35 prior to the performance of the seismic survey.

Seismic nodes 40 may comprise hydrophones, geophones, or other devices configured to detect seismic or acoustic energy. Seismic nodes 40 are also configured to record seismic energy 41 produced by seismic sources 45 as active seismic data. The node patch 38 may be defined by an outer periphery 42 within which nodes 40 are positioned at a substantially uniform node density throughout the node patch 38. In some embodiments the density of nodes will be higher in the area above the AOI 29. The density of seismic nodes 40 may be lower for nodes 40 that are not expected to be useful for imaging, but only for the purposes of updating the velocity model using full-waveform inversion (FWI), as will be discussed further herein. As used herein, the term “FWI” is defined as including all variants of full-waveform inversion. Certain examples of full-waveform inversion can use pressure and/or multi-component data. Certain examples of full-waveform inversion can use different approximations of physics (such as, for example, acoustic, elastic, visco-elastic, isotropic, and/or anisotropic). FWI can be used for different applications such as applications for estimating 3D velocities, applications for performing multi-parameter inversion, applications for deriving reflectivity volumes, applications for determining 4D difference volumes, applications for determining reflectivity gathers, and/or applications for determining probabilistic inversions, to name a few examples. Further, although the outer periphery 42 is shown as circular in this exemplary embodiment, in other embodiments, the outer periphery 42 of node patch 38 may be a variety of regular or irregular shapes.

In this exemplary embodiment, each seismic source 45 is connected to one of a pair of laterally spaced tow lines 46 each of which are connected to surface vessel 51. Although in this exemplary embodiment seismic sources 45 are connected to a pair of tow lines 46, in other embodiments, seismic sources 45 may be connected to surface vessel 51 via a single tow line 46 or more than two tow lines 46. During the performance of a seismic survey, surface vessel 51 travels back-and-forth in an inline direction (indicated by arrow 47 in FIG. 3) as the seismic sources 45 are each activated (sources 45 being positioned near but below the waterline 37) to generate seismic energy which is eventually received by at least some of the seismic nodes 40 of node patch 38. Following the completion of each pass of surface vessel 51 in the inline direction 47 across survey area 36, surface vessel 51 travels a predefined distance in an orthogonal crossline direction (indicated by arrow 48 in FIG. 3) before making a subsequent pass across the survey area 36 in the inline direction 47 travelling in the opposite direction therealong relative to the first pass of surface vessel 51. Over the course of the entire seismic survey, surface vessel 51 travels in a generally serpentine pattern

In this exemplary embodiment, the array 39 of seismic sources 45, upon activation, is configured to produce seismic energy 41 that travels through water column 23 and penetrates into the subsurface region 26. The seismic sources 45 may comprise conventional seismic airguns, vibratory sources, and/or other seismic sources, for example low-pressure high-volume compressed-air-release sources. Depending on the type of source, in some embodiments a “source point” may correspond to the activation of a single source, while in others a “source point” may correspond to the activation of an array of sources.

Following the deployment of seismic nodes 40 to the seabed 28 by a deployment vessel (not shown in FIG. 3) of survey system 35, surface vessel 51 travels across the waterline 37 as the array 39 of seismic sources 45 is activated in a predefined sequence, whereby a predefined pattern of source points (each corresponding to a location at which one or more of the seismic sources 45, forming the source array 39, is activated) are obtained, as will be described further herein. The seismic nodes 40 of node patch 38 capture seismic energy generated by the seismic sources 45 and reflected by the subsurface region 26 and record the captured seismic energy as active seismic data

Once the predefined pattern of source points has been obtained and the seismic energy generated by seismic sources 45, returning to the surface after interacting with subsurface region 26, has been recorded by seismic nodes 40 as active seismic data, the seismic nodes 40 may be retrieved from the seabed 28 by a retrieval vessel (not shown in FIG. 3) to the waterline 37 to complete the seismic survey.

Some seismic nodes 40 may remain stationary on the seabed 28 during the entirety of the performance of the seismic survey such that they remain in a single location throughout the entire seismic survey. These seismic nodes 40 are referred to herein as “static” seismic nodes given that their location is static throughout the performance of the seismic survey. Conversely, some seismic nodes 40 may be picked up and moved between different locations along the seabed 28 during the performance of the seismic survey. These latter seismic nodes 40 are referred to herein as “rolling” seismic nodes given that they occupy different locations along the seabed 28 during the performance of the seismic survey. Conventionally, survey systems employ a single type or classification of seismic node such as either all static seismic nodes or all rolling seismic nodes. FIG. 3 illustrates an example of a marine survey system 35 employing all static seismic nodes 40. Survey systems may employ all static seismic nodes in applications where many seismic nodes are readily available and/or where the survey area 36 is relatively small thus requiring a relatively small number of seismic nodes 40.

Following completion of the seismic survey, the active seismic data recorded by seismic sources 45 may be transferred to a computer system to analyze the seismic waveforms acquired by the seismic nodes 40 to determine seismic information regarding the geological structure, the location and property of hydrocarbon deposits, properties regarding the storage of carbon dioxide (CO2), waste, and water from industrial processes (e.g., hydraulic fracturing process) and the like within the subsurface region 26. For example, computer system may correct an initial velocity model associated with the subsurface region 26 using the active seismic data captured by the seismic nodes 40 and associated with the seismic survey performed by survey system 35. Additionally, the computer system may also be used to create one or more seismic images associated with the subsurface region 26 (including AOI 29) based on both the active seismic data captured by nodes 40 associated with the seismic survey performed by survey system 35 and on the corrected velocity model.

As described above, rather than employing static seismic nodes, some survey systems instead employ rolling seismic nodes which are moved during the performance of the seismic survey. This is typically done to minimize the number of seismic nodes required for performing the seismic survey given that for many applications utilizing only static seismic nodes would require an unrealistically large number of seismic nodes to perform the seismic survey. By utilizing rolling seismic nodes, the number of seismic nodes required for performing the seismic survey may be minimized while still providing sufficient seismic data for imaging the AOI 29.

Referring to FIGS. 4A-4C, another embodiment of a marine survey system 50 is shown. Particularly, marine survey system 50 is similar to the marine survey system 35 shown in FIG. 3 except, instead of employing static seismic nodes 40, marine survey system 50 includes a node patch 52 comprising a plurality of rolling seismic receivers or nodes (indicated generally by arrow 54 in FIGS. 4A-4C). FIG. 4A shows the node patch 52 in a first configuration defined by a first set of inline rows of rolling seismic nodes 54 with the outermost inline row disposed at a predefined maximum crossline offset 55 from the seismic sources 45. In other words, each of the rolling seismic nodes 54 are located at a crossline distance from the seismic sources 45 that is equal to or less than the maximum crossline offset 55. The magnitude of the crossline offset 55 may be selected based on, among other factors, the number of available rolling seismic nodes 54, the configuration of the subsurface region 26 and AOI 29, and the desired fidelity of the seismic imaging of the AOI 29.

During the performance of the seismic survey, the surface vessel 51 makes a first set of back-and-forth passes in the inline direction 47 across the survey area 36 with node patch 52 in the first configuration. After a predefined number of passes, each of the rolling seismic nodes 54 are retrieved from their first locations along the seabed 28 and repositioned in second locations (spaced in the crossline direction 48 from their first locations) along the seabed 28 in the crossline direction to place the node patch 52 in a second configuration as shown in FIG. 4B. For instance, node patch 52 may be transitioned from the first configuration to the second configuration once an innermost inline row of rolling seismic nodes 54 approaches the maximum crossline offset 55 as the surface vessel 51 travels in a serpentine manner across the survey area 36 in the crossline direction 48.

With node patch 52 in the second configuration, the seismic survey may be resumed with surface vessel 51 making a second set of back-and-forth passes in the inline direction 47 across the survey area 36 with node patch 52 in the second configuration. Again, after a predefined number of passes, each of the rolling seismic nodes 54 are retrieved from their second locations along the seabed 28 and repositioned in third locations (spaced in the crossline direction 48 from their first and second locations) along the seabed 28 in the crossline direction to place the node patch 52 in a third configuration as shown in FIG. 4C. In this example, with node patch 52 in the third configuration, the seismic survey may be resumed with surface vessel 51 making a third and final set of back-and-forth passes in the inline direction 47 across the survey area 36 with node patch 52 in the third configuration to complete the seismic survey.

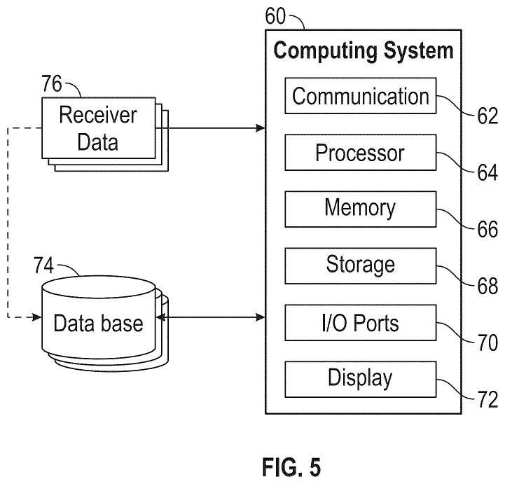

Referring now to FIG. 5, the computer system 60 may include a communication component 62, a processor 64, memory 66, storage 68, input/output (I/O) ports 70, and a display 72. In certain embodiments, the computer system 60 may omit one or more of the display 72, the communication component 62, and/or the input/output (I/O) ports 70. Communication component 62 may be a wireless or wired communication component that may facilitate communication between the receivers 25, 40, and 54, one or more databases 74, other computing devices, and/or other communication capable devices. In one embodiment, the computer system 60 may receive receiver data 76 (e.g., seismic data, seismograms, etc.) via a network component, the database 74, or the like. Processor 64 of the computer system 60 may analyze or process the receiver data 76 to ascertain various features regarding geological formations within the subsurface region 26 of the Earth.

Processor 64 may be any type of computer processor or microprocessor capable of executing computer-executable code. Processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by processor 64 to perform the presently disclosed techniques. Generally, processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computer system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. Memory 66 and storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computer system 60 to communicate with the other devices in the survey systems 22, 35, and 50, or the like via the I/O ports 70.

The display 72 may depict visualizations associated with software or executable code being processed by the processor 64. In one embodiment, display 72 may be a touch display capable of receiving inputs from a user of the computer system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via display 72, it should be noted that the computer system 60 may also depict the visualization via other tangible elements, such as paper (e.g., via printing) and the like.

With the foregoing in mind, the present techniques described herein may also be performed using a supercomputer that employs multiple computer systems 60, a cloud-computer system, or the like to distribute processes to be performed across multiple computer systems 60. In this case, each computer system 60 operating as part of a super computer may not include each component listed as part of the computer system 60. For example, each computer system 60 may not include the display 72 since multiple displays 72 may not be useful to for a supercomputer designed to continuously process seismic data.

After performing various types of seismic data processing, the computer system 60 may store the results of the analysis in one or more databases 74. The database 74 may be communicatively coupled to a network that may transmit and receive data to and from the computer system 60 via the communication component 62. In addition, databases 74 may store information regarding the subsurface region 26, such as previous seismograms, geological sample data, seismic images, and the like regarding the subsurface region 26.

Although the components described above have been discussed with regard to the computer system 60, it should be noted that similar components may make up the computer system 60. Moreover, the computer system 60 may also be part of the marine survey system 22, and thus may monitor and control certain operations of the seismic sources 24 and 45, the receivers 25, 40, and 54, and the like. Further, it should be noted that the listed components are provided as example components and the embodiments described herein are not to be limited to the components described with reference to FIG. 5.

In some embodiments, the computer system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross-sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computer system 60 may compare the two images to identify changes in the subsurface region 26. In any case, a seismic survey may be composed of a very large number of individual seismic recordings or traces. As such, the computer system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

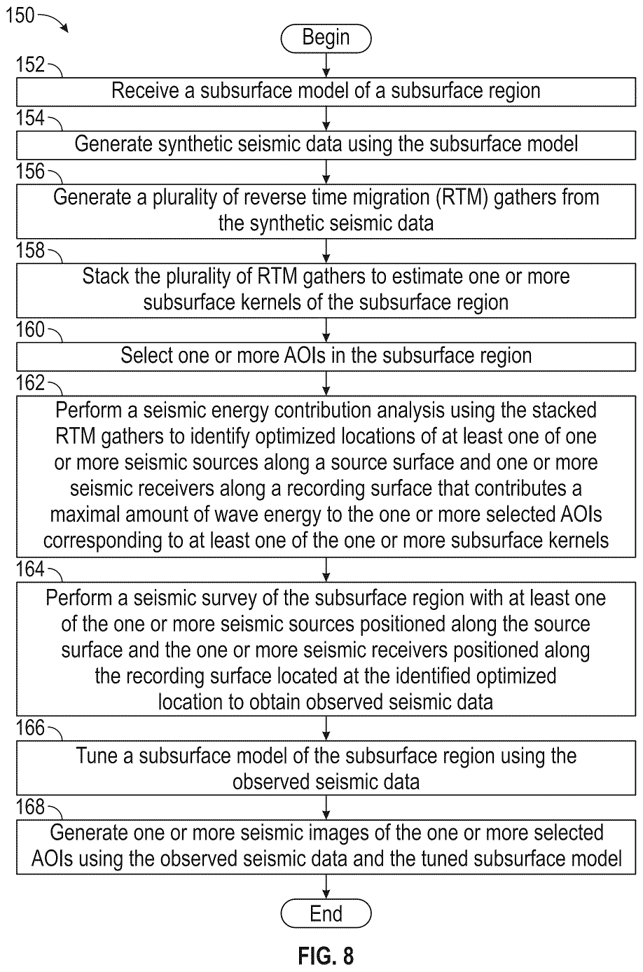

After the computer system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform method 10 of FIG. 1 that details various processes that may be undertaken based on the analysis of the acquired seismic data. Computer system 60 may be utilized to implement other methods described herein, such as method 150 shown in FIG. 8 and which will be described further herein.

Seismic imaging plays an important role in the exploration and characterization of subsurface structures such as hydrocarbon reservoirs, geological formations, and for monitoring potential hazards. However, seismic images derived from conventional imaging techniques may encounter various challenges that compromise the accuracy and reliability of the resulting images. For example, conventional migration-based imaging approaches, such as Reverse Time Migration (RTM), typically rely on back-propagating recorded wavefields using a predetermined velocity model to construct an image of the subsurface. These methods apply an imaging condition that correlates the forward-propagated source wavefield with the back-propagated receiver wavefield, essentially “stacking” energy to form an image of reflectivity. While effective in some applications, migration-based approaches can be limited by approximations in the wave physics, sensitivity to the velocity model accuracy, and challenges in handling complex geological features where multiple scattering and mode conversions occur.

In view of the above, seismic surveyors now increasingly employ inversion-based imaging techniques such as full-waveform inversion (FWI)-derived reflectivity (FDR) imaging which builds on the principles of FWI, a methodology that leverages the complete seismic wavefield—including both amplitude and phase information—to iteratively update the subsurface model. Rather than simply imaging reflectors through a migration condition, FDR imaging extracts reflectivity as part of a model-based inversion process that accounts for more comprehensive physics of wave propagation, under particular assumptions and embodiments of the ‘comprehensive physics’ implemented. This integrated approach enables the extraction of quantitative subsurface properties with higher resolution and fidelity. By fully exploiting the wavefield data, FDR imaging may provide enhanced resolution and more accurate amplitude recovery, leading to a more detailed and reliable depiction of subsurface reflectivity in at least some applications. Additionally, the model-based inversion framework of FDR imaging naturally incorporates complex wave phenomena such as multiple scattering and mode conversions, which are often inadequately handled by traditional migration techniques. Additionally, the iterative nature of FWI helps mitigate artifacts and acquisition footprint effects that can plague migration images, ultimately resulting in a more robust and quantitatively accurate subsurface model.

In addition to FDR imaging, FWI may also be leveraged to improve the performance of migration-based imaging techniques such as RTM imaging which may still be preferable to FDR imaging in some applications due to the increased computational demands of FDR imaging relative to migration-based imaging techniques. For example, FWI can significantly enhance migration-based seismic imaging by providing a highly accurate and high-resolution velocity model of the subsurface, which is crucial for effective wavefield extrapolation during migration. Particularly, in traditional migration methods, inaccuracies in the velocity model can lead to mispositioned reflectors and imaging artifacts. FWI, by iteratively minimizing the difference between observed and simulated seismic data, refines the velocity model using the complete amplitude and phase information contained in the wavefield. The improved subsurface model provided by FWI allows migration algorithms to more accurately back-propagate wavefields, resulting in clearer, better-aligned reflectivity images. Moreover, by incorporating the full physics of wave propagation, including complex phenomena like multiple scattering and mode conversions, FWI-derived imaging can more effectively resolve subtle geological features that might be obscured in conventional images. In essence, leveraging FWI in the imaging process not only mitigates the effects of model inaccuracies but also enriches the overall image quality, leading to a more reliable interpretation of subsurface structures.

The performance of FWI in both FDR imaging and in generating accurate and precise subsurface models is dependent on the observed seismic data obtained from the seismic survey (e.g., the seismic energy recorded by seismic receivers (e.g., seismic receivers 25, 40, and 54 described above). Particularly, the performance of FWI is dependent on the amount and type of seismic waves recorded by the seismic receivers of the survey system where seismic waves may propagate differently through the subsurface region.

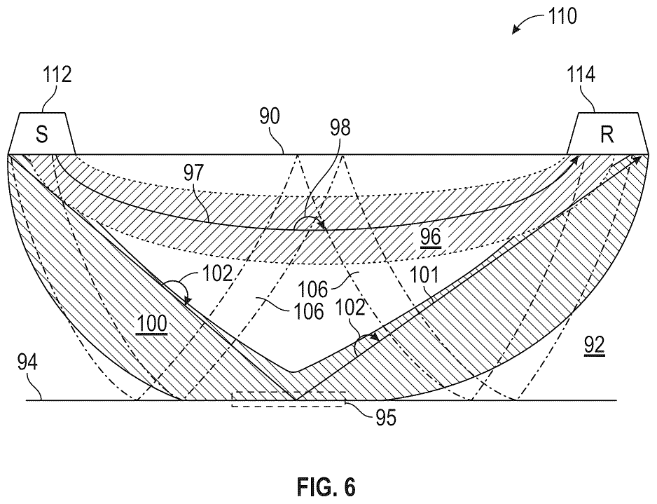

To provide an example, and referring to FIG. 6, another exemplary survey system 110 is shown including a seismic source 112 and a seismic receiver 114. Seismic source 112 generates a seismic source wavefield that travels through a subsurface region 92 extending beneath a terranean surface 90 and is which is eventually received by the seismic receiver 114. Some of the seismic energy propagating through the subsurface region 92 encounters and is reflected off of a subsurface reflector 94 while other seismic energy does not encounter the subsurface reflector 94.

System 110 includes a single seismic source 112 transmitting seismic energy through the subsurface region 92 that is received by a single seismic receiver 114 of system 110. Particularly, for a subsurface reflector of interest, different types of seismic waves such as seismic diving waves and seismic reflection waves, for example, tend to travel through or are concentrated in different spatial regions or zones (e.g., Fresnel zones) within the subsurface region. In the example provided by system 110, with respect to subsurface reflector 94, seismic energy in the form of seismic diving waves 97 tend to travel through a spatial first or diving subsurface zone or kernel 96 extending through the subsurface region 92 while seismic backscattered energy or “reflection waves” 101 tend to travel through a spatial second or reflection subsurface zone or kernel 100 that is at least partially separate (non-overlapping) from and unique with respect to the diving subsurface kernel 96.

Diving subsurface kernel 96 is sometimes referred to as the “banana” kernel due to its curved shape while reflection subsurface kernel 100 is sometimes referred to as the “rabbit-ears” kernel due again to its specific shape. As used herein, the term “subsurface kernel” refers to a defined region within a surrounding subsurface region in which particular kinds of corresponding seismic energy (e.g., diving seismic waves, reflection seismic waves) are channeled. Diving waves 97 are those waves that are refracted rather than reflected to/by the recording surface (e.g., terranean surface 90 in FIG. 6). Changes in the seismic velocity characteristic of the subsurface region (e.g., the subsurface region 92) gradually change the direction of propagation of the diving waves 97 to redirect them from a downward trajectory to an upward one. Additionally, the opening angle 98 along the diving energy path is equal to approximately 180° in this example. Conversely, reflected seismic waves 191 result from reflection at a reflector in the subsurface region (e.g., reflector 94 of subsurface region 92 in FIG. 6). The opening angle 102 along the reflected energy path of the seismic waves is approximately 180° in this example.

In addition to diving subsurface kernel 96 and reflection subsurface kernel 100, FIG. 5 also illustrates a multi-energy subsurface kernel 106 that is different in shape from both the diving subsurface kernel 96 and reflection subsurface kernel 100. In this example, multi-energy subsurface kernel 106 may include seismic waves that do not reflect off of the subsurface reflector 94 within the AOI 95. Further, although FIG. 6 only shows diving subsurface kernel 96, reflection subsurface kernel 100, and multi-energy subsurface kernel 106, additional subsurface kernels defining pathways of seismic energy may also be present in the subsurface region 92 that vary shape from subsurface kernels 96, 100, and 106. In other words, subsurface kernels 96, 100, and 106 are only examples of some subsurface kernels that may manifest within the subsurface region 92 in response to the operation of seismic source 112 and seismic receiver 114.

The direction of propagation of the seismic energy propagating along the different subsurface kernels (e.g., subsurface kernels 96 and 106, among others) present in the subsurface region 92 can be highly dependent on the seismic velocity of the subsurface region, making the capture of such seismic energy beneficial with respect to the performance of FWI using such observed seismic data. As one example, diving waves propagating along diving subsurface kernel 96 play a crucial role in FWI by providing valuable constraints on the shallow subsurface velocity structure. These waves, which propagate downward and then up again without reflecting off deep interfaces, are highly sensitive to the velocity gradients near the surface (e.g., terranean surface 90 in FIG. 6). This sensitivity is particularly important because an accurate near-surface velocity model is essential for correctly imaging deeper structures (e.g., subsurface reflector 94) and avoiding cycle-skipping during the inversion process. However, information obtained from the capture of seismic energy propagating along subsurface kernels other than diving subsurface kernel 96 (e.g., multi-energy subsurface kernel 106), may also be useful in FWI. By incorporating such seismic energy into the inversion, FWI can better resolve the subtle variations in velocity that influence the propagation of both diving, reflected, and/or other seismic waves, leading to a more robust and reliable background model. Ultimately, the improved velocity model enhances the overall accuracy of the inversion, ensuring that the full wavefield is correctly interpreted and resulting in higher fidelity seismic images of an AOI 95 targeting subsurface reflector 94, for example.

Further, in the example indicated in FIG. 6, the diving waves 97 travelling along diving subsurface kernel 96 do not intercept the subsurface reflector 94 and instead are located vertically above the subsurface reflector 94. In this instance, the recording of diving waves 97 facilitates maximizing the accuracy and precision of the subsurface model of subsurface region 92 using, for instance, FWI-based techniques. Further, seismic imaging of the AOI 95 and subsurface reflector 94 may be improved in turn using migration-based imaging techniques, the performance of which is dependent on the quality of the subsurface model. However, in other examples, recording diving waves 97 (and/or other seismic waves propagating along other subsurface kernels such as multi-energy subsurface kernel 106, for instance) may improve the quality of seismic imaging in ways other than simply improving the quality of the subsurface model of the subsurface region 92.

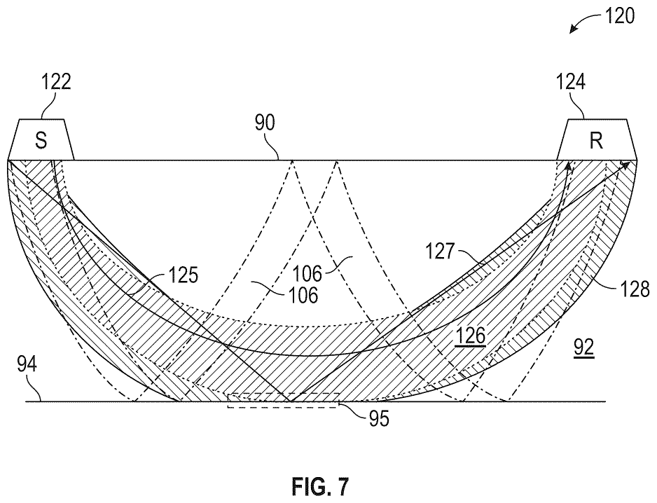

For instance, and referring to FIG. 7, another embodiment of a survey system 120 is shown including a seismic source 122 and a corresponding seismic receiver 124. In the example provided by system 120, with respect to subsurface reflector 94, seismic energy in the form of seismic diving waves 125 tend to travel through a spatial diving subsurface zone or kernel 126 extending through the subsurface region 92 while seismic reflection waves 127 travel through a reflection subsurface zone or kernel 128 that is at least partially separate (non-overlapping) from and unique with respect to the diving subsurface kernel 126. In the example shown in FIG. 7, the diving waves 125 travelling along diving subsurface kernel 126 intercept the subsurface reflector 94, unlike the diving waves 97 with respect to the subsurface reflector 94 shown in FIG. 6. As will be further discussed below, this may result due to a difference in positioning (e.g., offset distance) between the seismic source 122 and seismic receiver 124 relative to the positioning of seismic source 112 and seismic receiver 114 shown in FIG. 6. In this example, diving waves 125 may be used to directly image the AOI 95 and the subsurface reflector 94 using FDR imaging. Thus, FIG. 7 provides an example where diving waves 125 may be used to improve the performance of FDR imaging rather than indirectly improving the performance of migration-based imaging through improving the quality of the underlying subsurface model. In other examples, other types of seismic waves other than diving waves may intercept the AOI 95 such as seismic waves propagating along multi-energy subsurface kernel 106, for instance.

As described above, the trajectory of seismic energy (e.g., seismic energy propagating along subsurface kernels 106, 126, and 128 in FIG. 7) is dependent on the positioning of the seismic sources and seismic receivers of the survey system. For example, when a seismic source emits energy, diving waves propagate downward into the subsurface, gradually curving due to the velocity gradient and refracting back toward the surface. Additionally, their eventual emergence point is determined by both the source location and the subsurface velocity structure. Receivers must be strategically positioned to capture these waves at appropriate offsets, ensuring that the recorded data adequately samples the wavefield's turning points. This spatial relationship is critical in techniques such as FWI, where diving waves are leveraged to constrain the near-surface velocity model. A well designed acquisition geometry that optimally positions seismic sources and receivers enhances the coverage and quality of diving wave data (along with the coverage and quality of other seismic waves such as those propagating along multi-energy subsurface kernel 106), which in turn improves the resolution and accuracy of the subsurface velocity models used in seismic imaging.

Accordingly, embodiments of systems and methods for optimizing seismic surveys to enhance FWI for modelling subsurface regions are disclosed herein. Embodiments disclosed herein include optimizing the locations of seismic sources along a source surface and/or seismic receivers along a recording surface to maximize the contribution of selected subsurface kernels of the subsurface region (e.g., a diving subsurface kernel, a multi-energy subsurface kernel, and/or others) to facilitate subsequent refinement of a subsurface model of the subsurface region which may be used to generate an FDR seismic image of the subsurface region or for generating a seismic image using a migration-based imaging technique such as RTM. In certain embodiments, the optimization of the location of the seismic sources and/or seismic receivers is based on a seismic energy contribution analysis of potential locations of seismic sources and/or seismic receivers regarding the contribution of selected types of seismic wave energy made by these different locations. The seismic energy contribution analysis may be based on synthetic seismic data generated using an initial subsurface model of the subsurface region.

In some embodiments, the seismic survey may divide the seismic receivers thereof into a plurality of separate classes identified by unique maximum crossline offsets. In certain embodiments, the maximum crossline offset of a given class of seismic receivers may be based on the contribution of a selected type of seismic wave energy (e.g., diving wave energy) for the locations of the class of seismic receivers as determined from the seismic energy contribution analysis. In this manner, the locations having the greatest maximum crossline offset may be identified while locations having relatively smaller maximum crossline offsets may also be identified to permit transporting or “rolling” of this latter class of seismic receivers during the performance of the seismic survey to minimize the total number of seismic receivers required for the seismic survey.

Referring to FIG. 8, an exemplary method 150 for optimizing a seismic survey to enhance FWI for modeling a subsurface region is shown. Initially, method 150 includes at block 152 receiving a subsurface model of a subsurface region. The subsurface model estimates one or more parameters of the subsurface region at different locations therein. In some embodiments, the subsurface model comprises a grid-based velocity model of the subsurface region. The subsurface model may comprise an initial model that is later tuned using steps of method 150 as will be described further herein.

At block 154, method 150 includes generating synthetic seismic data using the subsurface model. For example, the synthetic seismic data may be generated at block 154 by simulating the forward propagation of a seismic source wavefield through the subsurface region modeled by the subsurface model. The simulated forward propagation of the seismic source wavefield may be based on the seismic wave equation and the subsurface model (e.g., velocity model) of the subsurface region to thereby model the propagation of seismic energy through the subsurface region. In certain embodiments, the synthetic seismic data is modeled as being received by a plurality of seismic receivers that are spaced apart from one another.

At block 156, method 150 includes generating a plurality of RTM gathers from the synthetic seismic data. In certain embodiments, block 156 comprises reverse propagating backwards through time from the synthetic seismic data through the subsurface region to generate the plurality of RTM gathers. Particularly, as used herein, the term “RTM gather” refers to a collection of seismic data (e.g., seismic data traces) obtained by applying RTM to receiver seismic data. The receiver seismic data used for obtaining RTM gathers may be observed or recorded in the field and thus may correspond to seismic data observed by one or more seismic receivers located at a survey area of a seismic survey. However, the receiver seismic data may also comprise synthetic seismic data. In this exemplary embodiment, the RTM gathers generated at block 156 are generated by applying RTM to the synthetic seismic data generated at block 154. In some embodiments, the RTM gathers obtained at block 156 comprises common image point (CIP) gathers in which each of the seismic traces of the CIP gather are migrated to a single CIP with the traces having different reflection or opening angles. Thus, the seismic traces of a CIP gather may be organized or sorted by their different opening angles. Alternatively, the RTM gathers may comprise common midpoint gathers (CMP) gathers in which the seismic traces reflect from the same subsurface reflector but with different seismic source-receiver offsets. RTM gathers may also comprise angle gathers in which the seismic traces are sorted base on reflection angles at the subsurface reflector.

In some embodiments, the plurality of RTM gathers generated at block 156 comprise a plurality of CIP gathers corresponding to a plurality of different CIPs within the subsurface region. Additionally, in certain embodiments, the plurality of RTM gathers (e.g., CIP gathers) each have large opening angles (e.g., opening angles 98 and 102 shown in FIG. 6) to focus the resulting RTM gathers on the reflection subsurface kernel, the diving subsurface kernel, the multi-energy subsurface kernel, and/or other selected subsurface kernels. In some embodiments, each of the seismic traces of the seismic gathers generated at block 156 has an opening angle equal to or greater than approximately 160° to focus the obtained RTM gathers on these specific subsurface kernels. In certain embodiments, a plurality of RTM gathers having large opening angles are obtained at block 156 by mapping the local wave-front directions through the subsurface region. In some embodiments, the RTM gathers may comprise three-dimensional (3D) seismic gathers to allow for the construction of azimuth of the different RTM gathers.

At block 158, method 150 includes stacking the plurality of RTM gathers to estimate one or more subsurface kernels of the subsurface region. In certain embodiments, the one or more subsurface kernels include the diving subsurface kernel, the multi-energy subsurface kernel, the reflection subsurface kernel, and/or other selected subsurface kernels of the subsurface region. In some embodiments, block 158 comprises stacking a plurality of RTM gathers (e.g., 3D RTM gathers) whereby the information contained in each seismic trace of a given RTM gather is combined such as by summation or linear stacking, weighted stacking, amplitude variation with angle (AVA) stacking, least-squares stacking, and the like, whereby a seismic image of a target location (e.g., a CIP) within the subsurface region is obtained. This stacking may be performed for each RTM gather to generate a plurality of seismic images of different target locations (e.g., the different CIPs of the seismic gathers) whereby a seismic image of the entire subsurface region or an AOI contained therein may be obtained. Further, from this seismic image obtained using the synthetic seismic data generated at block 154, the desired one or more subsurface kernels (e.g., diving, reflection, and/or multi-energy subsurface kernels) of the subsurface region may be estimated.

The one or more estimated subsurface kernels may define or estimate the travel path or Fresnel zone along which seismic waves corresponding to those one or more subsurface kernels travel through the subsurface region and which generally excludes other types of seismic waves that do not correspond to the one or more estimated subsurface kernels. For instance, and referring briefly again to FIG. 6, the estimated subsurface kernel may estimate the position and shape of the diving subsurface kernel 96, the reflection subsurface kernel 100, and/or the multi-energy subsurface kernel 106 within the subsurface region 92. In this manner, the position of diving subsurface kernel 96, the reflection subsurface kernel 100, and/or the multi-energy subsurface kernel 106 (e.g., as estimated at block 158 of FIG. 8) may be distinguished from other locations within the subsurface region 92 that fall outside of the subsurface kernels 96, 100, and/or 106. By distinguishing or segregating the subsurface kernels 96, 100, and 106 from the remainder of the subsurface region, the seismic energy directed along the subsurface kernels 96, 100, and/or 106 may similarly be segregated from the remainder of the seismic energy received by the seismic receiver 114 shown in FIG. 6. Additionally, subsurface kernels 96, 100, and/or 106 are discussed herein as an example, and additional subsurface kernels different in shape from subsurface kernels 96, 100, and 106 may be utilized at block 158.

At block 160, method 150 includes selecting one or more AOIs in the subsurface region (e.g., subsurface region 26 shown in FIGS. 2-4C, subsurface region 92 shown in FIGS. 6 and 7). The AOIs may be 2D or 3D and may comprise a subset or volume located within the larger and surrounding subsurface region. At block 162, method 150 includes performing a seismic energy contribution analysis using the RTM gathers to identify optimized locations of at least one of one or more seismic sources along a source surface and one or more seismic receivers along a recording surface that contributes a maximal amount of seismic energy to the selected AOIs and corresponding to at least one of the one or more subsurface kernels estimated at block 158. In some embodiments, the maximal amount of seismic energy corresponds to seismic wave energy corresponding to one or more selected subsurface kernels (e.g., diving wave energy of a diving subsurface kernel) estimated at block 158. In other words, in certain embodiments, block 162 comprises identifying optimized locations for positioning one or more seismic sources (e.g., seismic sources 24, 45, 112, and/or 122 described above) and/or one or more seismic receivers (e.g., seismic receivers 25, 40, 54, 114, and 124 described above) that contribute a maximal amount of seismic wave energy corresponding to the selected subsurface kernels estimated at block 158. As an example, block 162 may comprise determining optimized locations of static seismic nodes 40 and/or rolling seismic nodes 54 of a survey system. Indeed, block 162 may comprise determining optimized locations of both static seismic nodes and rolling seismic nodes of the same seismic survey.

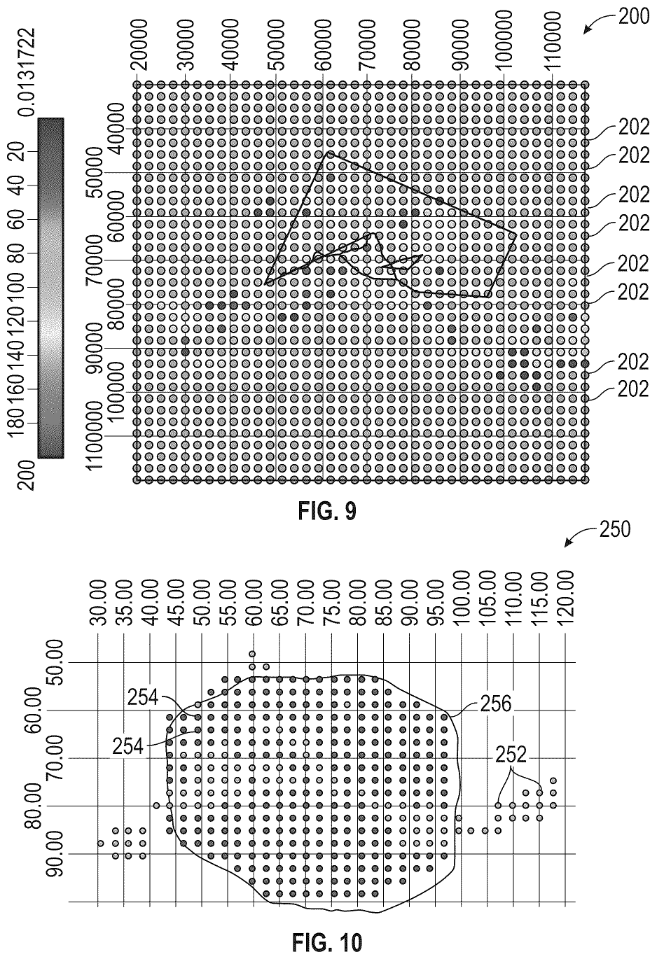

Referring to FIG. 9, diagram 200 is shown of an exemplary seismic energy contribution analysis. Particularly, diagram 200 illustrates a plurality of simulated seismic nodes 202 (only some of which are labeled in FIG. 9 for clarity) arranged in a grid (in a plan view in FIG. 9) along a recording surface such as the seafloor, a terranean surface, and the like. The seismic energy contribution analysis shown in diagram 200 measures the amount of diving wave illumination inside the AOI for each simulated seismic node 202.

Additionally, in this example, simulated seismic nodes 202 are shaded in diagram 200 in accordance with their contribution of diving wave energy for selected AOIs of a subsurface region and with respect to a given source location. In other words, the simulated seismic nodes 202 indicating a greater contribution of diving wave energy will, due to their location along the grid, receive a greater share of diving wave energy as a proportion of the total seismic energy received thereby. For this reason, the locations of the simulated seismic nodes 202 indicated in diagram 200 as having the greatest contribution of diving wave energy with respect to selected AOIs may be identified as optimized locations in accordance with block 162 of method 150.

Although diagram 200 illustrates an arrangement of simulated seismic nodes 202 along a recording surface, a similar seismic energy contribution analysis may be conducted in which a plurality of simulated seismic sources are arranged in a grid along a source surface such as a terranean surface, a waterline, and the like. Such a diagram may similarly identify optimized locations of seismic sources along the source surface for contributing a maximum amount or share of seismic wave energy of a selected subsurface kernel for selected AOIs. In some embodiments, block 162 of method 150 shown in FIG. 8 may include conducting said seismic energy contribution analysis for both one or more seismic receivers along a recording surface and for one or more seismic sources along a source surface.

Returning to FIG. 8, at block 164, method 150 includes performing a seismic survey of the subsurface region with at least one of the one or more seismic sources positioned along the source surface and the one or more seismic receivers positioned along the recording surface located at the identified optimized location to obtain observed seismic data. The observed seismic data may comprise recorded seismic energy or signals that have travelled through the subsurface region modeled by the initial subsurface model received at block 152. For instance, the observed seismic data may be initially generated as a seismic source wavefield by one or more seismic sources (e.g., seismic source 112 shown in FIG. 6) that has been injected or transferred through the subsurface region (portions of which reflect off various features or reflectors of the subsurface region) and subsequently received by one or more corresponding seismic receivers (e.g., seismic receiver 114 shown in FIG. 6). Thus, the seismic data obtained at block 164 comprises observed seismic data obtained directly from the subsurface region rather than the synthetic seismic data generated at block 154 and which is related to the subsurface region by the subsurface model received at block 152.

The seismic survey conducted at block 164 may be a land-based survey (e.g., performed using survey system 22 shown in FIG. 2) or a marine-based survey (e.g., performed using survey systems 35 or 50 shown in FIGS. 3 and 4A-4C). The seismic sources and/or seismic receivers may be strategically positioned during the performance of the seismic survey at block 164 at the identified optimized locations whereby the amount of seismic wave energy of one or more selected subsurface kernels recorded by the seismic receivers is maximized for the AOIs selected at block 160. The AOIs selected at block 160 may be at a location that is intercepted by the one or more selected subsurface kernels (the seismic energy along which is maximized by placing the seismic sources and/or receivers at the identified optimized locations) in some embodiments while in other embodiments the AOIs selected at block 160 may not be intercepted by the one or more selected subsurface kernels and instead may be spaced (e.g., located relatively deeper in the subsurface region) from the one or more selected subsurface kernels.

In some embodiments, method 150 additionally includes dividing the seismic receivers used in the seismic survey conducted at block 164 into static seismic receivers that occupy only one location and remain stationary during the performance of the seismic survey, and one or more classes of rolling seismic receivers that are moved at predefined intervals (e.g., at a predefined maximum crossline offset) during the performance of the seismic survey. The division of the seismic receivers into static and rolling seismic receivers may be based on the similar seismic energy contribution analysis performed at block 162. For instance, in an embodiment, the optimized locations having the greatest contribution of a selected seismic wave energy (e.g., diving wave energy) may be reserved for static seismic nodes given their importance in contributing to the selected seismic wave energy ultimately recorded by the seismic survey. Locations of seismic receivers other than the optimized locations and which thus contribute less to the selected seismic wave energy in this example may instead be reserved for rolling seismic receivers that are moved between locations along the recording surface in response to a maximum crossline offset being achieved (e.g., due to the movement of the one or more corresponding seismic sources in the crossline direction).

In some embodiments, the seismic survey performed at block 164 may divide the seismic receivers thereof into multiple separate classes of rolling seismic receivers each having a unique maximum crossline offset. For instance, a first class of rolling seismic receivers positioned at locations with an intermediate contribution to selected seismic wave energy may have a first maximum crossline offset while a second class of rolling seismic receivers positioned at locations with a lesser contribution to selected seismic wave energy may have a second maximum crossline offset that is less than the first maximum crossline offset, and so on and so forth across multiple additional classes of rolling seismic receivers. By utilizing both static seismic receivers and rolling seismic receivers in the same seismic survey, a given number of available seismic receivers may be utilized to record maximal amount of selected seismic wave energy thereby optimizing their use in performing the seismic survey. In still other embodiments, block 164 may include multiple classes of rolling seismic receivers having unique maximum crossline offsets but may not include any static seismic receivers depending on the size of the survey area, the number of available seismic receivers, and other parameters.

Referring to FIG. 10, a diagram 250 is shown of an exemplary distribution of seismic receivers along a recording surface in plan view. Particularly, diagram 250 illustrates the placement of both static seismic receivers 252 and a rolling seismic receivers 254 (only some of which are labeled in FIG. 10 for clarity) along a survey area 256. In this example, the distribution of static seismic receivers 252 corresponds to the distribution of simulated seismic receivers 202 shown in FIG. 9 that have the greatest contribution of diving wave energy and thus have the greatest maximum crossline offset which equals or exceeds a crossline width of the survey area 256 itself. In this example, static seismic receivers 252 remain stationary during the performance of the seismic survey conducted at block 164 shown in FIG. 8 while rolling seismic receivers 254 are moved between different locations along the recording surface in accordance with a predefined maximum crossline offset. However, if the size of survey area 256 were sufficiently increased, seismic receivers 252 and 254 may each comprise rolling seismic receivers with seismic receivers 252 having a greater maximum crossline offset than that of seismic receivers 254 such that seismic receivers 252 are moved or “rolled” less often than seismic receivers 254.

At block 166, method 150 comprises a tuning subsurface model of the subsurface region using the observed seismic data. In some embodiments, block 166 comprises implementing FWI using the observed seismic data obtained at block 164 and the initial subsurface model received at block 152 and which may serve as a preliminary approximation of the subsurface region. Particularly, the observed seismic data from block 164 may be compared with synthetic seismic data obtained from the initial velocity model using an objective function that quantifies their differences, typically based on amplitude and phase discrepancies between the observed seismic data and the synthetic seismic data. To reduce this misfit between the observed and synthetic seismic data, the gradient of the objective function may be determined with respect to the parameters of the subsurface model to reveal how the subsurface model should be tuned. An optimization algorithm may be employed using this gradient information to update the subsurface model iteratively. Specifically, with each iteration of the FWI process, synthetic seismic data is regenerated and compared to the observed seismic data obtained at block 164, progressively refining the subsurface model until the differences between the synthetic and observed seismic data are sufficiently minimized. This iterative process ultimately yields a high-resolution, tuned or final subsurface model that more accurately represents the subsurface region, significantly enhancing seismic imaging and interpretation.

At block 168, method 150 includes generating one or more seismic images of the one or more selected AOIs using the tuned subsurface model obtained at block 166. The seismic images generated at block 168 may be obtained using different techniques depending on the location of the AOIs selected at block 160. For instance, if the AOIs are not intercepted by the selected subsurface kernel (e.g., as with diving subsurface kernel 96 shown in FIG. 6), then a migration-based imaging technique (e.g., RTM and the like) may be utilized for generating the seismic images relying on reflected seismic waves traveling along the reflection subsurface kernel (also captured in the observed seismic data) where the improvement to the resolution of the generated seismic images provided by method 150 lies in the improvement made to the tuned subsurface model utilized in the migration-based imaging technique in generating the seismic images.

Conversely, in applications where the AOIs are intercepted by the selected subsurface kernel (e.g., as with diving subsurface kernel 126 shown in FIG. 7), then the seismic images may be generated directly from the tuned subsurface model as FDR seismic images. For example, the derivative of the subsurface model at the locations of the AOIs may be determined to generate the FDR seismic images of the AOIs without needing to employ a migration-based imaging technique such as RTM. In some instances, the locations of the AOIs may be strategically selected to correspond to locations in the subsurface region where the quality of the initial velocity model is particularly poor so as to maximize the seismic wave energy of the selected subsurface kernel travelling through this location to improve the quality of the subsurface model. Thus, initial AOIs may not correspond to the location of a subsurface reflector or other feature of interest of the subsurface region and instead may be used primarily to improve the quality of the subsurface model. Further AOIs may then be selected that are not necessarily intercepted by the one or more subsurface kernels and which correspond to features of interest of the subsurface region which may be imaged using migration-based imaging techniques such as RTM.

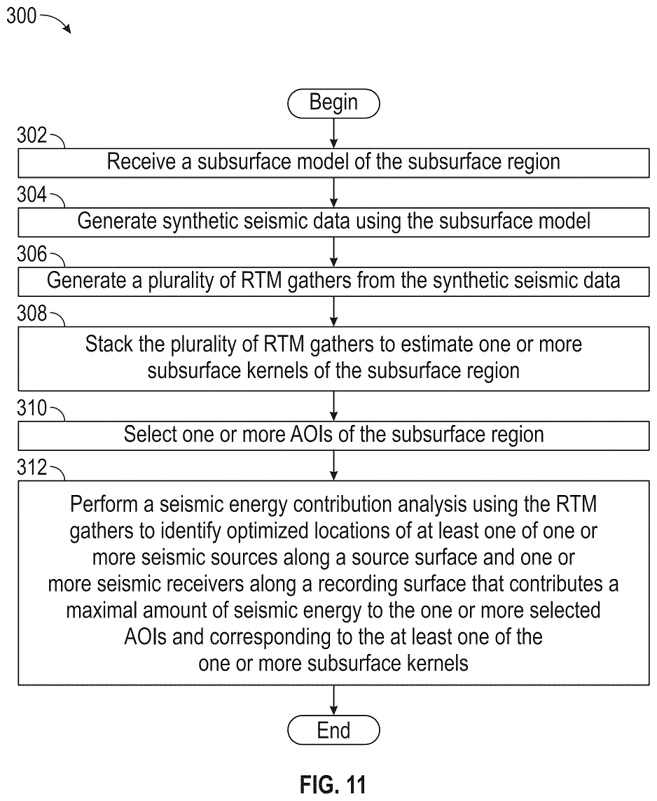

Referring to FIG. 11, another exemplary method 300 for optimizing a seismic survey to enhance FWI for modeling a subsurface region (e.g., subsurface region 26 shown in FIGS. 2 and 3, subsurface region 92 shown in FIG. 6) is shown. Initially, at block 302, method 300 includes receiving a subsurface model of the subsurface region. At block 304, method 300 includes generating synthetic seismic data using the subsurface model. At block 306, method 300 includes generating a plurality of RTM gathers from the synthetic seismic data. At block 308, method 300 includes selecting one or more AOIs (e.g., AOI 29 shown in FIG. 3) of the subsurface region. At block 310, method 300 incudes performing a seismic energy contribution analysis (e.g., the seismic energy contribution analysis shown in diagram 200 of FIG. 9) using the RTM gathers to identify optimized locations of at least one of one or more seismic sources (e.g., seismic source 24 shown in FIG. 2, seismic sources 45 shown in FIG. 3, seismic source 112 shown in FIG. 6) along a source surface (e.g., surface 27 shown in FIG. 2, waterline 37 shown in FIG. 3, terranean surface 90 shown in FIG. 6) and one or more seismic receivers (e.g., seismic receivers 25 shown in FIG. 2, seismic nodes 40 shown in FIG. 3, seismic receiver 114 shown in FIG. 6) along a recording surface (e.g., surface 27 shown in FIG. 2, seafloor 28 shown in FIG. 3, terranean surface 90 shown in FIG. 6) that contributes a maximal amount of seismic energy to the one or more selected AOIs and corresponding to the at least one of the one or more subsurface kernels (e.g., subsurface kernels 96 and 100 shown in FIG. 6, subsurface kernels 126 and 128 shown in FIG. 7).

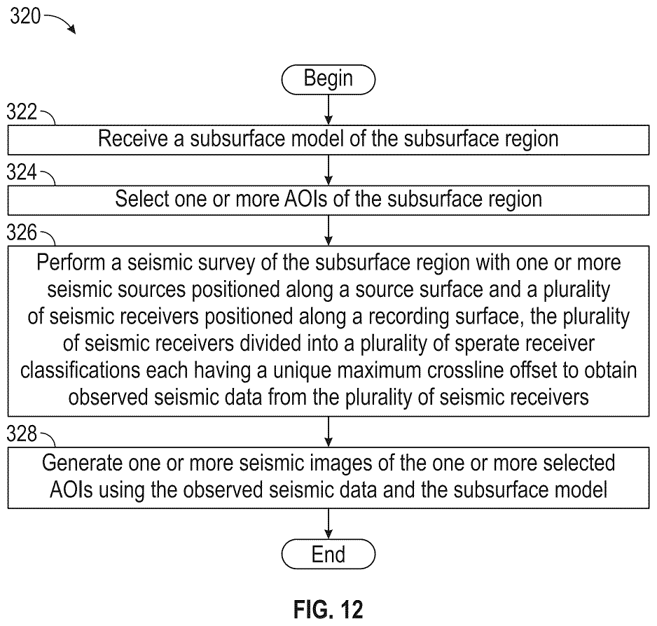

Referring to FIG. 12, another exemplary method 320 for optimizing a seismic survey to enhance FWI for modeling a subsurface region (e.g., subsurface region 26 shown in FIGS. 2 and 3, subsurface region 92 shown in FIG. 6) is shown. Initially, at block 322, method 300 includes receiving a subsurface model of the subsurface region. At block 324, method 320 includes selecting one or more AOIs (e.g., AOI 29 shown in FIG. 3) of the subsurface region. At block 326, method 320 includes performing a seismic survey of the subsurface region with one or more seismic sources (e.g., seismic source 24 shown in FIG. 2, seismic sources 45 shown in FIG. 3, seismic source 112 shown in FIG. 6) positioned along a source surface (e.g., surface 27 shown in FIG. 2, waterline 37 shown in FIG. 3, terranean surface 90 shown in FIG. 6) and a plurality of seismic receivers (e.g., seismic receivers 25 shown in FIG. 2, seismic nodes 40 shown in FIG. 3, seismic receiver 114 shown in FIG. 6) positioned along a recording surface (e.g., surface 27 shown in FIG. 2, seafloor 28 shown in FIG. 3, terranean surface 90 shown in FIG. 6), the plurality of seismic receivers divided into a plurality of separate receiver classifications each having a unique maximum crossline offset to obtain observed seismic data from the plurality of seismic receivers. At block 328, method 320 includes generating one or more seismic images of the one or more selected AOIs using the observed seismic data and the subsurface model.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps but rather are used to simplify subsequent reference to such steps.

What is claimed is:

1. A method for optimizing a seismic survey to enhance full-waveform inversion (FWI) for modeling a subsurface region, the method comprising:
(a) receiving a subsurface model of a subsurface region;
(b) generating synthetic seismic data using the subsurface model;
(c) generating a plurality of reverse time migration (RTM) gathers from the synthetic seismic data;
(d) stacking the plurality of RTM gathers to estimate one or more subsurface kernels of the subsurface region;
(e) selecting one or more areas of interest (AOIs) of the subsurface region; and
(f) performing a seismic energy contribution analysis using the RTM gathers to identify optimized locations of at least one of one or more seismic sources along a source surface and one or more seismic receivers along a recording surface that contributes a maximal amount of seismic energy to the one or more selected AOIs and corresponding to the at least one of the one or more subsurface kernels.

2. The method of claim 1, further comprising:
(g) performing a seismic survey of the subsurface region with at least one of the one or more seismic sources positioned along the source surface and the one or more seismic receivers positioned along the recording surface located at the identified optimized location to obtain observed seismic data.

3. The method of claim 2, wherein (g) comprises dividing the one or more seismic sources into a plurality of separate seismic source classes based on the seismic energy contribution analysis, wherein each of the plurality of separate seismic source classes has a unique maximum crossline offset.

4. The method of claim 2, wherein (g) comprises dividing the one or more seismic sources into one or more static seismic receivers and one or more rolling seismic receivers.

5. The method of claim 2, further comprising:
(h) tuning the subsurface model of the subsurface region using the observed seismic data.

6. The method of claim 5, further comprising:
(i) generating one or more seismic images of the subsurface region using the observed seismic data.

7. The method of claim 1, wherein the optimized locations contribute the maximal amount of seismic energy to the one or more selected AOIs and at least one subsurface kernel of the one or more subsurface kernels other than a reflection subsurface kernel that intercepts the one or more selected AOIs.

8. The method of claim 7, wherein the one or more selected AOIs are intercepted by the at least one subsurface kernel.

9. The method of claim 7, wherein the one or more selected AOIs are not intercepted by the at least one subsurface kernel.

10. A method for optimizing a seismic survey to enhance full-waveform inversion (FWI) for modeling a subsurface region, the method comprising:
(a) receiving a subsurface model of a subsurface region;
(b) selecting one or more areas of interest (AOIs) of the subsurface region; and
(c) performing a seismic survey of the subsurface region with one or more seismic sources positioned along a source surface and a plurality of seismic receivers positioned along a recording surface, the plurality of seismic receivers divided into a plurality of separate receiver classifications each having a unique maximum crossline offset to obtain observed seismic data from the plurality of seismic receivers; and
(d) generating one or more seismic images of the one or more selected AOIs using the observed seismic data and the subsurface model.

11. The method of claim 10, wherein (c) comprises:
(c1) transporting the one or more seismic sources across a survey area of the seismic survey in a crossline direction;
(c2) transporting a first class of seismic receivers of the plurality of seismic receivers across the recording surface in response to the one or more seismic receivers reaching a first maximum crossline offset of the first class of seismic receivers relative to the one or more seismic sources as the one or more seismic sources travel in the crossline direction; and
(c3) transporting a second class of seismic receivers of the plurality of seismic receivers across the recording surface in response to the one or more seismic receivers reaching a second maximum crossline offset of the second class of seismic receivers relative to the one or more seismic sources as the one or more seismic sources travel in the crossline direction, wherein the second maximum crossline offset is greater than the first maximum crossline offset.

12. The method of claim 11, wherein (c2) comprises transporting the first class of seismic receivers in the crossline direction across the recording surface.

13. The method of claim 10, wherein (c) comprises:
(c1) transporting the one or more seismic sources across a survey area of the seismic survey in a crossline direction;
(c2) maintaining a first class of seismic receivers of the plurality of seismic receivers in a static location along the recording surface until completion of the seismic survey; and
(c3) transporting a second class of seismic receivers of the plurality of seismic receivers across the recording surface in response to the one or more seismic receivers reaching a maximum crossline offset of the second class of seismic receivers relative to the one or more seismic sources as the one or more seismic sources travel in the crossline direction.

14. The method of claim 10, further comprising:
(e) performing a seismic energy contribution analysis to identify optimized locations of the plurality of seismic receivers along the recording surface that contributes a maximal amount of diving wave energy to the one or more selected AOIs.

15. The method of claim 14, wherein seismic receivers of the plurality of seismic receivers located at the optimized locations along the recording surface have a maximum crossline offset that is greater than a maximum crossline offset of other seismic receivers of the plurality of seismic receivers that are not located at the optimized locations.

16. A system comprising:
a one or more processors; and
a storage device coupled to the one or more processors, the storage device configured to store instructions that, when executed by the one or more processors, configure the one or more processors to:
(a) receive a subsurface model of a subsurface region;
(b) generate synthetic seismic data using the subsurface model;
(c) generating a plurality of reverse time migration (RTM) gathers from the synthetic seismic data;
(d) stack the plurality of RTM gathers to estimate one or more subsurface kernels of the subsurface region; and
(e) perform a seismic energy contribution analysis using the RTM gathers to identify optimized locations of at least one of one or more seismic sources along a source surface and one or more seismic receivers along a recording surface that contributes a maximal amount of seismic energy to one or more selected area of interest (AOIs) and corresponding to the at least one of the one or more subsurface kernels.

17. The system of claim 16, wherein the instructions, when executed by the one or more processors, configure the one or more processors to:
(f) receive observed seismic data from the subsurface region; and
(g) tune subsurface model of the subsurface region using the observed seismic data.

18. The system of claim 17, wherein the instructions, when executed by the one or more processors, configure the one or more processors to:
(h) generate one or more seismic images of the subsurface region using the observed seismic data.

19. The system of claim 16, wherein the optimized locations contribute the maximal amount of seismic energy to the one or more selected AOIs and at least one subsurface kernel of the one or more subsurface kernels other than a reflection subsurface kernel that intercepts the one or more selected AOIs.

20. The system of claim 19, wherein the one or more selected AOIs are intercepted by the at least one subsurface kernel.

21. The system of claim 19, wherein the one or more selected AOIs are not intercepted by the at least one subsurface kernel.
